(19) United States
(12) Patent Application Publication
(10) Pub. No.: US 2016/0182691 A1
(43) Pub. Date: Jun. 23, 2016

(54) System and Method for Operating Dual-Stack Devices

(71) Applicant: Futurewei Technologies, Inc., Plano, TX (US)

(72) Inventors: Simon Perreault, Quebec (CA); Marc Blanchet, Quebec (CA); Ting Zou, Shenzhen (CN); Zhongjian Zhang, Shenzhen (CN)

(21) Appl. No.: 14/578,241

(22) Filed: Dec. 19, 2014

(51) Int. Cl. H04L 29/06; H04L 29/12

(52) U.S. Cl. CPC H04L 69/167; H04L 61/251

(57) ABSTRACT

A method for interacting with Internet Protocol version 6 (IPv6) compatible devices in a communications system includes receiving a first control message from a server, the dual-stack device comprising an Internet Protocol version 4 (IPv4) protocol stack and an IPv6 protocol stack, wherein the first control message includes an IPv4 level indicator that indicates support for IPv4 in the communications system, and adjusting a configuration of the IPv4 protocol stack in accordance with the IPv4 level indicator.

### TECHNICAL FIELD

The present disclosure relates generally to computer communications, and more particularly to a system and method for operating dual-stack devices.

### BACKGROUND

In computer communications, there is a migration from Internet Protocol (IP) version 4 (IPv4) to IPv6 in order to provide support for a much larger address space, amongst other reasons. However, there remain millions of devices that are only IPv4 compatible. Therefore, there is a transition period where both IPv4 and IPv6 are supported.

Some devices available during the transition period support both IPv4 and IPv6. In supporting both IPv4 and IPv6, these devices implement both an IPv4 protocol stack and an IPv6 protocol stack. Such devices may be referred to as dual-stack devices. Dual-stack devices can provide connectivity in both IPv4 and IPv6 networks.

### SUMMARY OF THE DISCLOSURE

Example embodiments of the present disclosure which provide a system and method for system and method for operating dual-stack devices.

In accordance with an example embodiment of the present disclosure, a method for interacting with Internet Protocol version 6 (IPv6) compatible devices in a communications system is provided. The method includes receiving, by a dual-stack device, a first control message from a server, the dual-stack device comprising an Internet Protocol version 4 (IPv4) protocol stack and an IPv6 protocol stack, wherein the first control message includes an IPv4 level indicator that indicates support for IPv4 in the communications system, and adjusting, by the dual-stack device, a configuration of the IPv4 protocol stack in accordance with the IPv4 level indicator.

In accordance with another example embodiment of the present disclosure, a method for interacting with Internet Protocol version 6 (IPv6) and Internet Protocol version 4 (IPv4) compatible devices is provided. The method includes determining, by a server, an IPv4 level indicator in accordance with IPv4 support in a communications system including the server, generating, by the server, a first control message, where the first control message includes the IPv4 level indicator, and sending, by the server, the first control message.

In accordance with another example embodiment of the present disclosure, a dual-stack device is provided. The dual-stack device includes an Internet Protocol version 4 (IPv4) protocol stack and an Internet Protocol version 6 (IPv6) protocol stack, a receiver, and a processor operatively coupled to the receiver, to the IPv4 protocol stack, and the IPv6 protocol stack. The receiver receives a first control message from a server, wherein the first control message includes an IPv4 level indicator that indicates support for IPv4 in a communications system. The processor adjusts a configuration of the IPv4 protocol stack in accordance with the IPv4 level indicator.

In accordance with another example embodiment of the present disclosure, a method for interacting with Internet Protocol version 6 (IPv6) dynamic host configuration protocol (DHCPv6) compatible devices in a communications system is provided. The method includes receiving, by a dual-stack device, a first DHCPv6 control message from a DHCPv6 server, the dual-stack device comprising an Internet Protocol version 4 (IPv4) protocol stack and an IPv6 protocol stack, wherein the first control message includes an IPv4 level indicator that indicates support for IPv4 in the communications system, and adjusting, by the dual-stack device, a configuration of the IPv4 protocol stack in accordance with the IPv4 level indicator.

One advantage of an embodiment is that techniques for shutting down an IPv4 protocol stack of a dual-stack device are provided. Shutting down the IPv4 protocol stack when IPv4 is not supported can reduce communications system overhead by eliminating IPv4 request messages. Furthermore, power consumption in the dual-stack devices is also reduced since there is no longer a need to wake up and transmit the IPv4 request messages when there are no IPv4 response messages.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates an example communications system according to example embodiments described herein;

FIG. 2 illustrates an example message exchange diagram involving a dual-stack device 205 and an IPv6 only router according to example embodiments described herein;

FIG. 3 illustrates an example option included in a DHCPv6 response message to indicate a level of IPv4 functionality supported according to example embodiments described herein;

FIG. 4 illustrates an example option included in a Neighbor Discovery router advertisement message to indicate a level of IPv4 functionality supported according to example embodiments described herein;

FIG. 5a illustrates a flow diagram of example operations occurring in a dual-stack device using DHCPv6 request and response messages to obtain configuration information according to example embodiments described herein;

FIG. 5b illustrates a flow diagram of example operations occurring in a dual-stack device using a Neighbor Discovery router advertisement message to obtain configuration information according to example embodiments described herein;

FIG. 6a illustrates a flow diagram of example operations occurring in a DHCPv6 server that uses DHCPv6 response messages to provide configuration information according to example embodiments described herein;

FIG. 6b illustrates a flow diagram of example operations occurring in a DHCPv6 server that uses DHCPv6 Reconfigure messages to provide configuration information according to example embodiments described herein;

FIG. 7 illustrates an example first communications device according to example embodiments described herein;

FIG. 8 illustrates an example second communications device according to example embodiments described herein; and

FIG. 9 illustrates an example communications system with different IP devices according to example embodiments described herein.

### DETAILED DESCRIPTION OF ILLUSTRATIVE EMBODIMENTS

The operating of the current example embodiments and the structure thereof are discussed in detail below. It should be appreciated, however, that the present disclosure provides many applicable inventive concepts that can be embodied in a wide variety of specific contexts. The specific embodiments discussed are merely illustrative of specific structures of the disclosure and ways to operate the disclosure, and do not limit the scope of the disclosure.

One embodiment of the disclosure relates to operating dual-stack devices. For example, a dual-stack device receives a first IPv6 dynamic host configuration protocol (DHCPv6) message from an IPv6 router, the dual-stack device comprising an Internet Protocol version 4 (IPv4) protocol stack and an IPv6 protocol stack, wherein the first DHCPv6 message includes an IPv4 level indicator that indicates whether the IPv6 router supports IPv4 compatibility, and adjusts a configuration of the IPv4 protocol stack in accordance with the IPv4 level indicator.

The present disclosure will be described with respect to example embodiments in a specific context, namely communications systems that are capable of supporting both IPv4 and IPv6. The disclosure may be applied to standards compliant communications systems and non-standards compliant communications systems that support both IPv4 and IPv6.

When a device first connects to a network, it obtains configuration information that it needs to attach to the network. In IPv4, this is achieved by sending a request to a dynamic host configuration protocol (DHCP) server. The DHCP server responds with configuration information for the device. DHCPv6 is similar to DHCP and is used in IPv6 network. DHCP may be referred to as DHCPv4 to prevent confusion. In IPv6, there is a second way to provide configuration information: a Neighbor Discovery (ND) Router Advertisement (RA) message allows IPv6 routers to periodically send messages offering configuration information to listening devices.

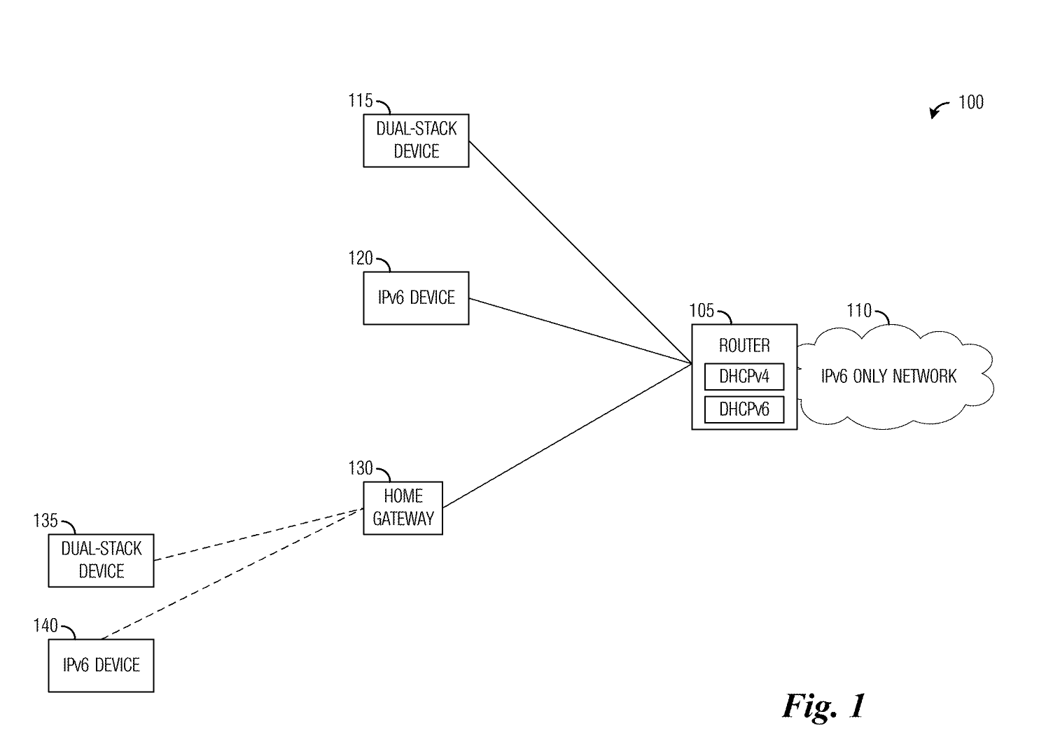

FIG. 1 illustrates an example communications system 100. Communications system 100 includes a router 105 serving as an entry and an egress from an IPv6 only network 110. Although router 105 serves IPv6 only network 110, router 105 may include support for both IPv4 and IPv6. As such, router 105 may include a DHCP server and a DHCPv6 server, with a DHCP server for IPv4 being referred to as a DHCPv4 server. Router 105 may also include a Neighbor Discovery server. For discussion purposes, consider a situation where the DHCPv4 server is shut down, meaning that router 105 has disabled IPv4 support for downstream devices.

Communications system 100 may also include a plurality of devices, such as a dual-stack device 115, an IPv6 device 120. As discussed previously, a dual-stack device is a device that includes both an IPv4 protocol stack and an IPv6 protocol stack. Communications system 100 may also include a dual stack device referred to as a home gateway 130, which may serve as a router for devices that are members of a local network serviced by home gateway 130. As shown in FIG. 1, members of the local network serviced by home gateway 130 include a dual-stack device 135, an IPv6 device 140. Home gateway 130 may include DHCPv4 and/or DHCPv6 servers and/or Neighbor Discovery server. Devices connected to home gateway 130 may include devices that listen to DHCP messages and are able to obtain IPv4 configuration information from home gateway 130, and Neighbor Discovery (ND) devices that listen for ND messages from home gateway 130.

While it is understood that communications systems may employ multiple routers capable of communicating with a number of devices, only one router, and a number of devices are illustrated for simplicity.

Since the DHCPv4 server of router 105 is shutdown, dual-stack device 115 and Home gateway (dual-stack) 130 may not be able to obtain IPv4 configuration information from router 105 and is therefore, unable to communicate with other IPv4 devices in communications system 100. There are no messages in the DHCPv4 protocol that can be used to let a device know that IPv4 is not available. However, since both dual-stack device 115 and IPv6 device 120 have IPv6 protocol stacks, they may be able to obtain configuration information from router 105 and are therefore, capable of communicating with other IPv6 devices in communications system 100.

Dual-stack device 135 and IPv6 device 140 may be able to obtain IPv6 configuration information from home gateway 130 by IPv6. However, depending on the configuration of home gateway 130 and control messages, i.e., whether or not home gateway 130 continually serves IPv4 (e.g., home gateway 130 has shut down its DHCPv4 server), IPv4 protocol stack in dual-stack device 135 may or may not be able to obtain IPv4 configuration information.

As discussed previously, a dual-stack device may request configuration information from both a DHCPv4 server (using a DHCPv4 request message) and a DHCPv6 server (using a DHCPv6 request message). However, if there isn't a DHCPv4 server, there will never be a response to the DHCPv4 request message and the dual-stack device may continually send out DCHPv4 request messages, needlessly filling the network with such messages.

When a dual-stack device does not receive responses to its DHCPv4 requests, the aggregated traffic generated by multiple such dual-stack nodes can represent a significant useless load. As an example, this scenario may be encountered when an Internet service provider (ISP) serving multiple types of subscribers (with some subscribers being IPv4 devices and some subscribers being IPv6 devices) and where it is not feasible to block the DHCPv4 requests. In addition to the useless load, a significant amount of communications system bandwidth may be consumed by the DHCPv4 requests, especially when the DHCPv4 requests are sent on a low-bandwidth channel. Furthermore, a dual-stack device that does not receive a DHCPv4 response may continue to send DHCPv4 requests indefinitely. As an illustrative example, in a popular IPv4 client implementation, a dual-stack device may wake up every 5 minutes to contact a DHCPv4 server for a 60 second duration. In such a configuration, the dual-stack device is prevented from sleeping at least 20% of the time.

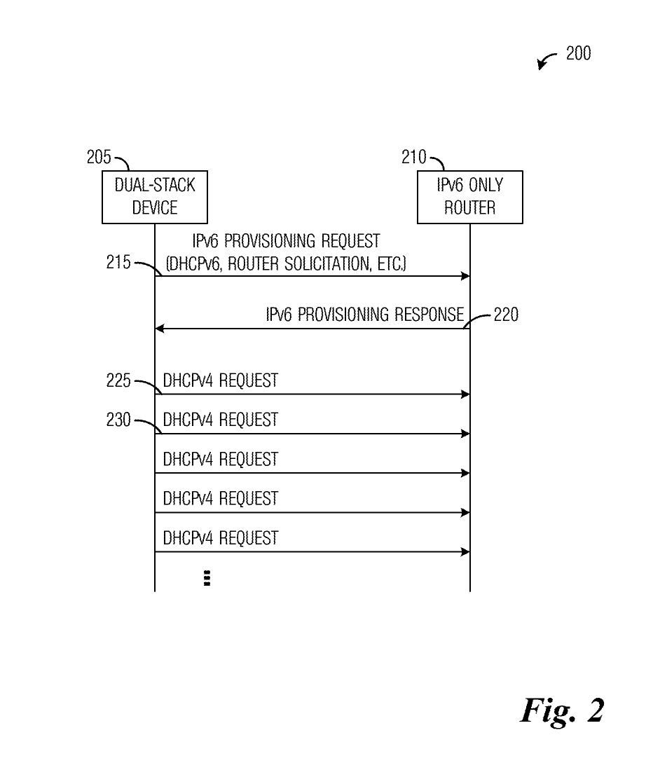

FIG. 2 illustrates an example message exchange diagram 200 involving a dual-stack device 205 and an IPv6 only router 210. Although the discussion focuses on an IPv6 only router, a similar message exchange may occur with a router that supports both IPv4 and IPv6 with the IPv4 support disabled. Therefore, the focus on an IPv6 only router should not be construed as being limiting to either the scope or the spirit of the example embodiments.

Dual-stack device 205 may request configuration information from a DHCPv6 server in IPv6 only router 210 by sending an IPv6 provisioning request message, i.e., a DHCPv6 request message (shown as event 215). IPv6 only router 210 may respond with an IPv6 provisioning response message, i.e., a DHCPv6 response message (shown as event 220). It is noted that depending on implementation, DHCPv6 (as well as DHCPv4) servers may be implemented as stand-alone devices or co-located with other devices. The configuration information contained in the IPv6 provisioning response message may enable dual-stack device 205 to obtain IPv6 connectivity.

However, since dual-stack device 205 also includes IPv4 functionality, dual-stack device 205 may also send an IPv4 request message, i.e., DHCPv4 request message (shown as event 225) to obtain configuration information from a DHCPv6 server in IPv6 only router 210 (which does not exist or isn't enabled). However, since IPv6 only router 210 doesn't support DHCPv4, the DHCPv4 request message goes unanswered. After a time-out period, dual-stack device 205 may send another IPv4 request message (shown as event 230). After yet another time-out period, dual-stack device 205 may send another IPv4 request message, and so on.

According to an example embodiment, an option is included in a DHCPv6 message to indicate a level of IPv4 functionality supported. A recipient of the DHCPv6 message that includes the option can configure its IPv4 operation (e.g., its IPv4 protocol stack) accordingly.

According to an example embodiment, an option is included in a DHCPv6 request message to indicate a level of IPv4 functionality supported. The DHCPv6 request message includes an option that indicates the level of IPv4 functionality supported. As an illustrative example, the levels of IPv4 functionality supported may include: IPv4 fully enabled; no IPv4 upstream; no IPv4 upstream with local IPv4 restricted; and no IPv4 at all. Although four levels of IPv4 functionality are illustrated, fewer or greater numbers of levels are possible.

According to an example embodiment, an option is included in a DHCPv6 response message to indicate a level of IPv4 functionality supported. The DHCPv6 response message includes an option that indicates the level of IPv4 functionality supported. As an illustrative example, the levels of IPv4 functionality supported may include: IPv4 fully enabled; no IPv4 upstream; no IPv4 upstream with local IPv4 restricted; and no IPv4 at all. Although four levels of IPv4 functionality are illustrated, fewer or greater numbers of levels are possible.

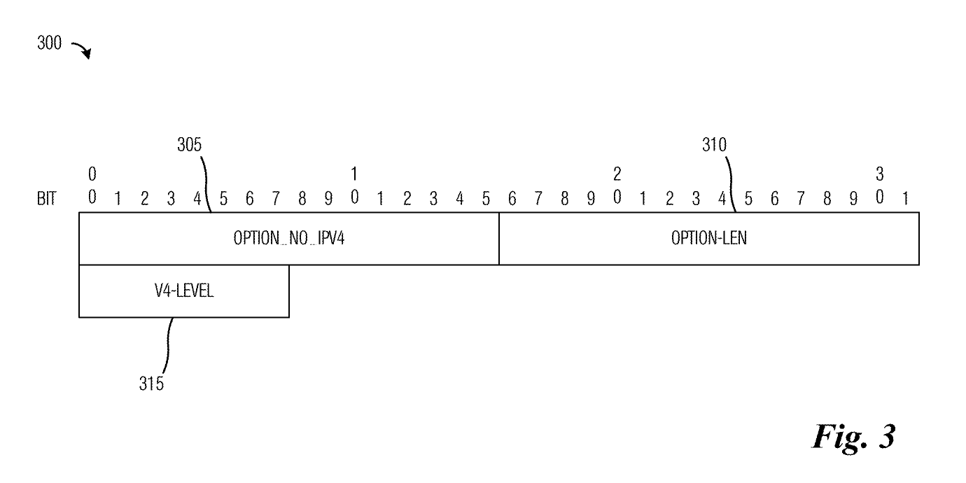

FIG. 3 illustrates an example option 300 included in a DHCPv6 response message to indicate a level of IPv4 functionality supported. Option 300 may include an option number field (OPTION_NO_IPV4) 305 that includes a numerical value indicating that the option is used to indicate the level of IPv4 functionality supported, an option length field (OPTION-LEN) 310 that includes a numerical value indicating the length of an indicator of the level of IPv4 functionality supported, and an indicator field (V4-LEVEL) 315 that includes the indicator of the level of IPv4 functionality supported. As an illustrative example, option number field 305 may be 2 octets in size, option length field 310 may be 2 octets in size, and indicator field 315 may be 1 octet is size.

Option 300 may also be included in a DHCPv6 request message. The inclusion of option 300 in a DHCPv6 request message may be used in conjunction with a gateway that does not provide IPv4 service and the gateway may send the DHCPv6 request message with option 300 to a DHCPv6 server. The DHCPv6 server may send a DHCPv6 response message with option 300 with indicator field 315 set to a commensurate value. As an illustrative example, consider the communications system shown in FIG. 1, where home gateway 130 does not provide IPv4 service. Home gateway 130 may send a DHCPv6 request with option 300. Router 105 may send a DHCPv6 response with indicator field 315 set to “No IPv4 upstream, local IPv4 restricted”. Router 105 may subsequently reclaim IPv4 addresses and drop all IPv4 packets from home gateway 130. Home gateway 130 may, after receiving the DHCPv6 response with indicator set to “No IPv4 upstream, local IPv4 restricted”, abort IPv4 provisioning, deactivate IPv4 functionality, and shut down its DHCPv4 server.

According to an example embodiment, an option is included in a DHCPv6 reconfigure message to indicate a level of IPv4 functionality supported. The DHCPv6 reconfigure message includes an option that indicates the level of IPv4 functionality supported. As an illustrative example, the levels of IPv4 functionality supported may include: IPv4 fully enabled; no IPv4 upstream; no IPv4 upstream with local IPv4 restricted; and no IPv4 at all. Although four levels of IPv4 functionality are illustrated, fewer or greater numbers of levels are possible.

Although the discussion of option 300 shown in FIG. 3 focuses on DHCPv6 response messages, option 300 may also be included in DHCPv6 request messages and DHCPv6 reconfigure message. Therefore, the focus on DHCPv6 response messages should not be construed as being limiting to either the scope or spirit of the example embodiments.

According to an example embodiment, an option is included in a Neighbor Discovery router advertisement message to indicate a level of IPv4 functionality supported. The Neighbor Discovery router advertisement message includes an option that indicates the level of IPv4 functionality supported. As an illustrative example, the levels of IPv4 functionality supported may include: IPv4 fully enabled; no IPv4 upstream; no IPv4 upstream with local IPv4 restricted; and no IPv4 at all. Although four levels of IPv4 functionality are illustrated, fewer or greater numbers of levels are possible.

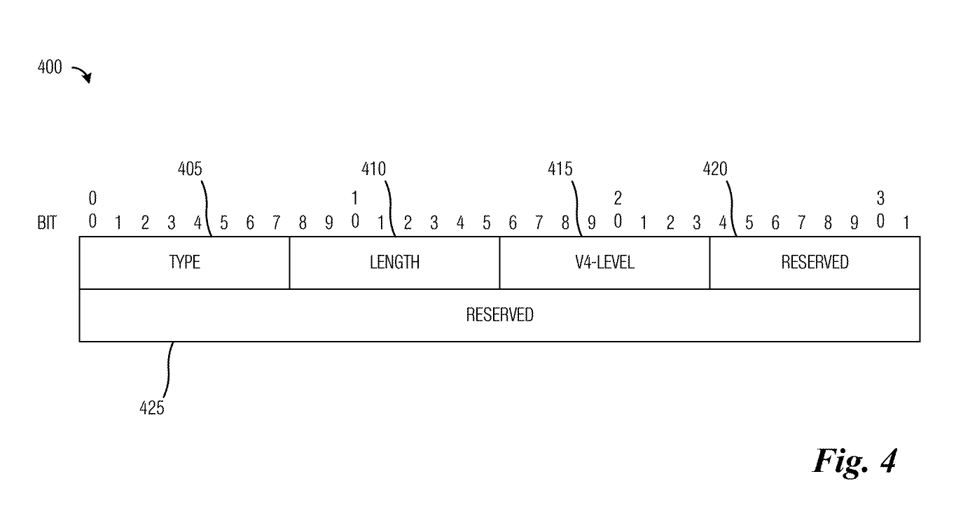

FIG. 4 illustrates an example option 400 included in a Neighbor Discovery router advertisement message to indicate a level of IPv4 functionality supported. Option 400 may include a Type field 405 that includes a numerical value indicating the option is used to indicate the level of IPv4 functionality supported, a Length field 410 that includes a numerical value indicating the length of an indicator of the level of IPv4 functionality supported, and an indicator field (V4-LEVEL) 415 that includes the indicator of the level of IPv4 functionality supported. Option 400 also includes a first reserved field 420 and a second reserved field 425 that may be subsequently used for other purposes. As an illustrative example, Type field may be 1 octet in length, Length field 410 may be 1 octet in length, and indicator field 415 may be 1 octet in length. First reserved field 420 and second reserved field 425 may be 1 octet and 4 octets in length, respectively.

Referring back now to the illustrative example involving the communications system shown in FIG. 1, home gateway 130 may send a DHCPv6 response message (or a DHCPv6 reconfigure message) with option 300 or a Neighbor Discovery router advertisement message with option 400 set to indicate dual-stack devices to configure IPv4 operation in accordance with indicator fields of the respective options. The options may be used to signal unavailability of IPv4 functionality.

In general, the various messages discussed herein (e.g., DHCPv6 request message, DHCPv6 response message, DHCPv6 reconfigure message, Neighbor Discovery router advertisement message, and the like) may be collectively referred to as control messages. Except where note, any and/or all of these types of messages may be referred to as control messages.

Dual-stack devices may include the option in a DHCPv6 Request. DHCPv6 servers may include the option in responses if they have been so configured. DHCPv6 servers may also place the option in a DHCPv6 Reconfigure message.

As an illustrative example, the indicator fields of option 300 and option 400 included in a control message may include indicator field values set to the following values:
0—IPv4 fully enabled: This is equivalent to the absence of the option. It may be included here so that a DHCPv6 server can explicitly re-enable IPv4 access by including it in a Reply message following a Reconfigure, or similarly by a router in a spontaneous Router Advertisement.
1—No IPv4 upstream: Any kind of IPv4 upstream connectivity is unavailable on the link on which the option is received. Therefore, any attempts to provision IPv4 by a host or to use IPv4 in any fashion, on that link, will be useless. IPv4 may be dropped, blocked, or otherwise ignored on that link. Upon reception of the option with indicator set to value 1, the following IPv4 functionality may be disabled on the Upstream Interface:
   IPv4 addresses may not be assigned;
   Currently-assigned IPv4 addresses may be unassigned;
   Dynamic configuration of link-local IPv4 addresses may be disabled;
   IPv4, ICMPv4 (Internet Control Message Protocol version four), or ARP (Address Resolution Protocol) packets may not be sent;
   IPv4, ICMPv4, or ARP packets received may be ignored; and
   DNS (Domain Name System) A queries may not be sent even transported over IPv6.
2—No IPv4 upstream, local IPv4 restricted: Same semantics as value 1, with the following additions:
   If all DHCPv6- or RA-configured interfaces receive the OPTION_NO_IPv4 option (an option that indicates the level of IPv4 functionality supported) with a mix of values 1, 2, and 3 (but not exclusively 3), and no other interface provides IPv4 connectivity to the Internet, IPv4 is partially shut down, leaving only local connectivity active. On the Upstream Interface, IPv4 MUST be shut down as listed above. On other interfaces, IPv4 addresses MUST NOT be assigned except for the following:
      Loopback (127.0.0.0/8);
      Link Local (169.254.0.0/16); and
      Private-Use (10.0.0.0/8, 172.16.0.0/12, 192.168.0.0/16).
3—No IPv4 at all: This is intended to be a stricter version of the above value 1 & 2. A host or router receiving this option may disable IPv4 functionality on the Upstream Interface in the same way as for value 1 or 2. If all DHCPv6- or RA-configured interfaces received the OPTION_NO_IPv4 option with exclusively value 3, and no other interface provides IPv4 connectivity to the Internet, IPv4 is completely shut down. In particular:
   IPv4 address may not be assigned to any interface;
   Currently-assigned IPv4 addresses may be unassigned;
   Dynamic configuration of link-local IPv4 addresses may be disabled;
   IPv4, ICMPv4, or ARP packets may not be sent on any interface;
   IPv4, ICMPv4, or ARP packets received on any interface may be ignored;
   In the above, “any interface” includes loopback interfaces. In particular, the 127.0.0.1 special address may be removed;
   Server programs listening on IPv4 addresses (e.g., a DHCPv4 server) may be shut down;
   DNS A queries may not be sent even transported over IPv6;
   If the host or router also runs a DHCPv6 server, it may include the option with indicator set to value 2 in DHCPv6 responses it sends to clients that request it, unless prohibited by local policy. If it currently has active clients, it may send a Reconfigure to each of them with the option included in the Option Request Option;
   If the router sends Router Advertisement, it may include the option with indicator set to value 2 in RA messages it sends, unless prohibited by local policy. It may also send RAs immediately so that the changes take effect for all current hosts; and
   The intent is to remove all traces of IPv4 activity. Once the option with indicator set to value 3 is activated, the network stack should behave as if IPv4 functionality had never been present. As an illustrative example, a modular kernel implementation could accomplish the above by unloading the IPv4 kernel module at run time.

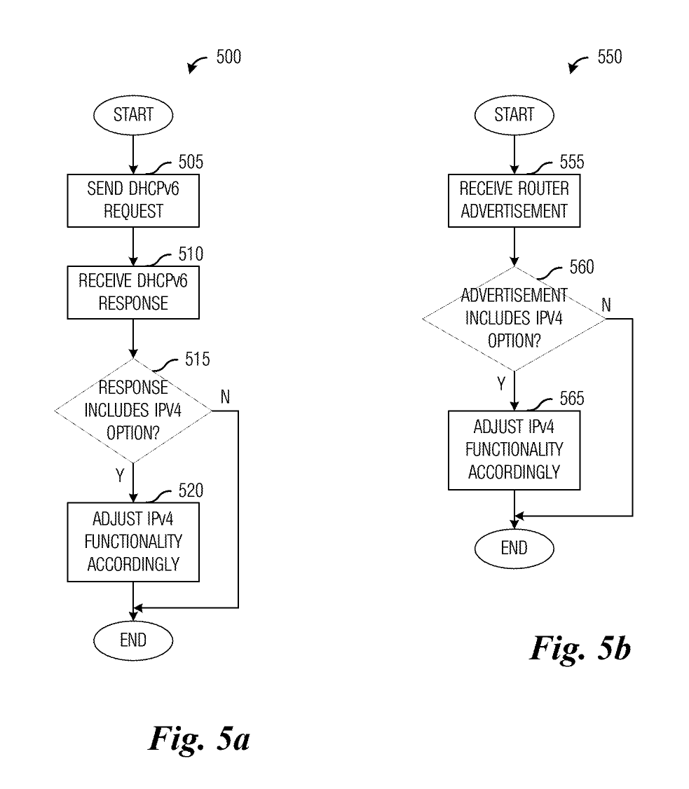

FIG. 5a illustrates a flow diagram of example operations 500 occurring in a dual-stack device using DHCPv6 request and response messages to obtain configuration information. Operations 500 may be indicative of operations occurring in a dual-stack device, such as dual-stack device 115 and dual-stack device 135, as the dual-stack device uses DHCPv6 request and response messages to obtain configuration information.

Operations 500 may begin with the dual-stack device sending a DHCPv6 request message to obtain configuration information (block 505). The dual-stack device may receive a DHCPv6 response message from a DHCPv6 server (block 510). The dual-stack device may perform a check to determine if the DHCPv6 response message includes an option (block 515) that indicates the level of IPv4 functionality supported. If the DHCPv6 response message does include such an option, the dual-stack device may adjust its IPv4 functionality in accordance with the option (block 520). As an illustrative example, the dual-stack device may configure its IPv4 protocol stack to refrain from sending DHCPv4 messages when the option indicates that IPv4 is not supported. If the DHCPv6 response message does not include an option that indicates the level of IPv4 functionality supported, operations 500 may terminate.

FIG. 5b illustrates a flow diagram of example operations 550 occurring in a dual-stack device using a Neighbor Discovery router advertisement message or DHCPv6 reconfigure message to obtain configuration information. Operations 550 may be indicative of operations occurring in a dual-stack device, such as dual-stack device 115 and dual-stack device 135, as the dual-stack device uses a Neighbor Discovery router advertisement message or a DHCPv6 reconfigure message to obtain configuration information.

Operations 550 may begin with the dual-stack device receiving a Neighbor Discovery router advertisement message from a Neighbor Discovery server or a DHCPv6 reconfigure message from a DHCPv6 server (block 555). The dual-stack device may perform a check to determine if the Neighbor Discovery router advertisement message or the DHCPv6 reconfigure message includes an option that indicates the level of IPv4 functionality supported (block 560). If the Neighbor Discovery router advertisement message or the DHCPv6 reconfigure message does include such an option, the dual-stack device may adjust its IPv4 functionality in accordance with the option (block 565). As an illustrative example, the dual-stack device may configure its IPv4 protocol stack to refrain from sending DHCPv4 messages when the option indicates that IPv4 is not supported. If the Neighbor Discovery router advertisement message or the DHCPv6 reconfigure message does not include an option that indicates the level of IPv4 functionality supported, operations 550 may terminate.

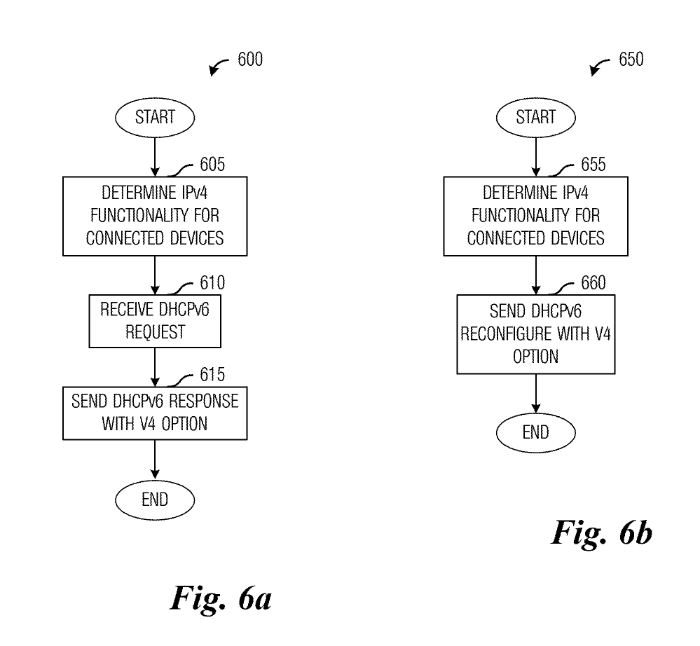

FIG. 6a illustrates a flow diagram of example operations 600 occurring in a DHCPv6 server that uses DHCPv6 response messages to provide configuration information. Operations 600 may be indicative of operations occurring in a DHCPv6 server, such as a DHCPv6 server located in router 105, as the DHCPv6 server uses DHCPv6 response messages to provide configuration information.

Operations 600 may begin with the DHCPv6 server determining IPv4 functionality for connected devices (block 605). The IPv4 functionality for connected devices may be specified by an operator of a communications system that includes the DHCPv6 server, for example. The DHCPv6 server may receive a DHCPv6 request message (block 610). The DHCPv6 server may send a DHCPv6 response message back to an originator of the DHCPv6 request message, where the DHCPv6 response message includes an option indicating a level of IPv4 functionality (block 615).

FIG. 6b illustrates a flow diagram of example operations 650 occurring in a DHCPv6 server that uses DHCPv6 reconfigure messages to provide configuration information. Operations 650 may be indicative of operations occurring in a DHCPv6 server, such as a DHCPv6 server located in router 105, as the DHCPv6 server uses DHCPv6 reconfigure messages to provide configuration information.

Operations 650 may begin with the DHCPv6 server determining IPv4 functionality for connected devices (block 655). The IPv4 functionality for connected devices may be specified by an operator of a communications system that includes the DHCPv6 server, for example. The DHCPv6 server may send a DHCPv6 reconfigure message, where the DHCPv6 reconfigure message includes an option indicating a level of IPv4 functionality (block 660). The DHCPv6 server may periodically send the same DHCPv6 reconfigure message or it may modify the DHCPv6 reconfigure message as changes are dictated.

As discussed previously, a Neighbor Discovery router advertisement message may also include an option, such as option 400. In such a situation, a Neighbor Discovery server may determine IPv4 functionality for connected deices and may send a Neighbor Discovery router advertisement message that includes the option. The Neighbor Discovery server may periodically send the same Neighbor Discovery router advertisement message or it may modify the Neighbor Discovery router advertisement message as changes are dictated.

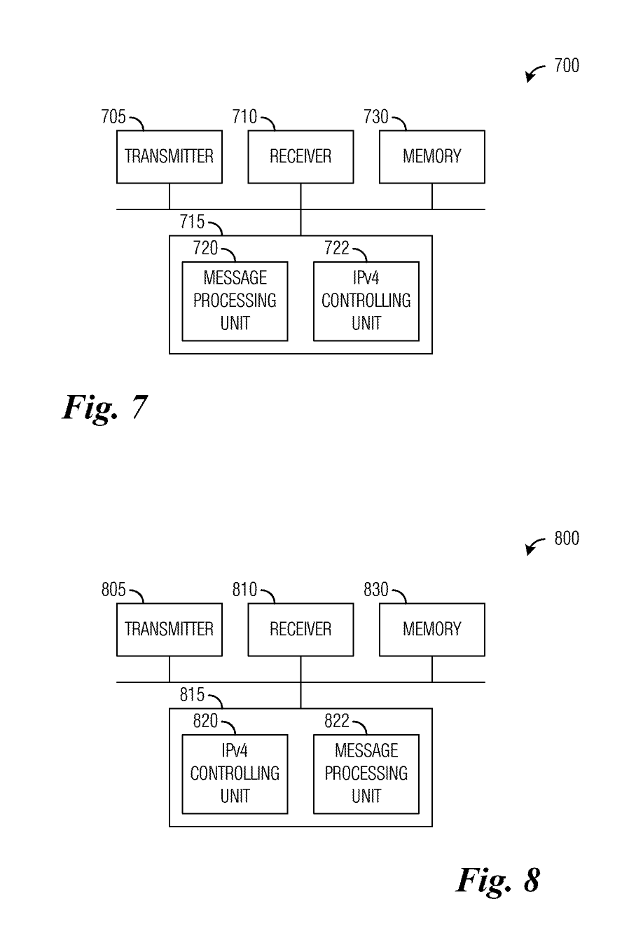

FIG. 7 illustrates an example first communications device 700. Communications device 700 may be an implementation of a dual-stack device. Communications device 700 may be used to implement various ones of the embodiments discussed herein. As shown in FIG. 7, a transmitter 705 is configured to transmit packets, DHCPv4 request messages, DHCPv6 request messages, and the like. Communications device 700 also includes a receiver 710 that is configured to receive packets, DHCPv4 response messages, DHCPv6 response messages, DHCPv6 reconfigure messages, Neighbor Discovery router advertisements, and the like.

A message processing unit 720 is configured to generate a DHCPv4 request message and/or a DHCPv6 request message to request configuration information. Message processing unit 720 is configured to process received DHCPv4 response messages, DHCPv6 response messages, DHCPv6 reconfigure messages, and/or Neighbor Discovery router advertisement messages. Message processing unit 720 is configured to determine if received DHCPv6 response messages, DHCPv6 reconfigure messages, and/or Neighbor Discovery router advertisement messages include options that indicate the level of IPv4 functionality supported. An IPv4 controlling unit 722 is configured to adjust IPv4 functionality of communications device 700 in accordance with an option, such as option 300 or 400. Memory 730 is configured to store information, DHCPv4 response messages, DHCPv6 response messages, DHCPv6 reconfigure messages, Neighbor Discovery router advertisement messages, options, IPv4 configurations, and the like.

The elements of communications device 700 may be implemented as specific hardware logic blocks. In an alternative, the elements of communications device 700 may be implemented as software executing in a processor, controller, application specific integrated circuit, or so on. In yet another alternative, the elements of communications device 700 may be implemented as a combination of software and/or hardware.

As an example, receiver 710 and transmitter 705 may be implemented as a specific hardware block, while message processing unit 720 and IPv4 controlling unit 722 may be software modules executing in a microprocessor (such as processor 715) or a custom circuit or a custom compiled logic array of a field programmable logic array. Message processing unit 720 and IPv4 controlling unit 722 may be modules stored in memory 730.

FIG. 8 illustrates an example second communications device 800. Communications device 800 may be an implementation of a device including a DHCPv6 server and/or a Neighbor Discovery server. Communications device 800 may be used to implement various ones of the embodiments discussed herein. As shown in FIG. 8, a transmitter 805 is configured to transmit packets, DHCPv6 response messages, DHCPv6 reconfigure messages, Neighbor Discovery router advertisement messages, and the like. Communications device 800 also includes a receiver 810 that is configured to receive packets, DHCPv6 request messages, and the like.

An IPv4 controlling unit 820 is configured to determine an IPv4 functionality of communications devices. IPv4 controlling unit 820 is configured to generate an option in accordance with the IPv4 functionality. A message processing unit 820 is configured to generate a DHCPv6 response message and/or a DHCPv6 reconfigure message that includes configuration information and the option. Message processing unit 820 is configured to generate a Neighbor Discovery router advertisement message that includes configuration information and the option. Message processing unit 822 is configured to process received DHCPv6 request messages. Memory 830 is configured to store information, DHCPv6 request messages, DHCPv6 response messages, DHCPv6 response messages, Neighbor Discovery router advertisement messages, options, IPv4 configurations, and the like.

The elements of communications device 800 may be implemented as specific hardware logic blocks. In an alternative, the elements of communications device 800 may be implemented as software executing in a processor, controller, application specific integrated circuit, or so on. In yet another alternative, the elements of communications device 800 may be implemented as a combination of software and/or hardware.

As an example, receiver 810 and transmitter 805 may be implemented as a specific hardware block, while IPv4 controlling unit 820 and message processing unit 822 may be software modules executing in a microprocessor (such as processor 815) or a custom circuit or a custom compiled logic array of a field programmable logic array. IPv4 controlling unit 820 and message processing unit 822 may be modules stored in memory 830.

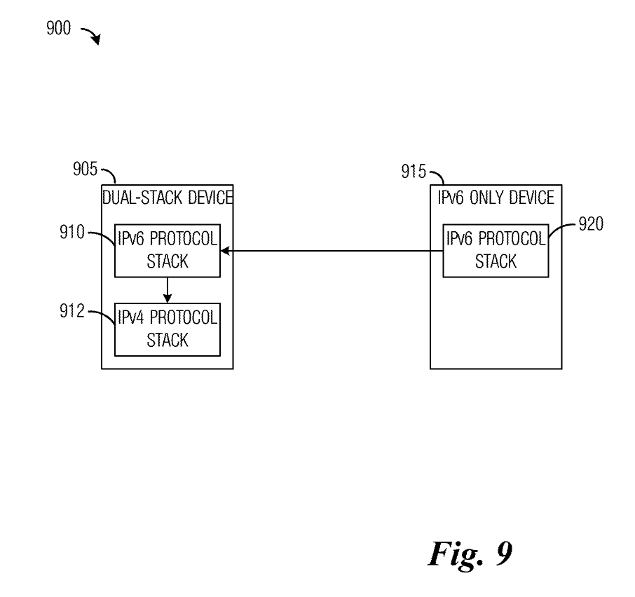

FIG. 9 illustrates an example communications system 900 with different IP devices. Communications system 900 includes a dual-stack device 905 with an IPv6 protocol stack 910 and an IPv4 protocol stack 912, as well as an IPv6 only device 915 with an IPv6 protocol stack 920. IPv6 protocol stack 910 may implement DHCPv6 and/or Neighbor Discovery clients and listens for information from DHCPv6 servers and/or Neighbor Discovery servers. IPv4 protocol stack 912 may implement IPv4 functions and may receive control messages from IPv6 protocol stack 910. The control messages may include an option regarding IPv4 functionality as described herein. The option may include an indicator that indicates one of the following: IPv4 fully enabled; No IPv4 upstream; No IPv4 upstream, local IPv4 restricted; and No IPv4 at all. IPv6 protocol stack 920 may implement a DHCPv6 server and/or Neighbor Discovery server. IPv6 protocol stack 920 may listen to information from DHCPv6 and/or Neighbor Discovery clients. It may be configured by operators of communications system 900. It may select configuration information from some IPv6 clients.

Although the present disclosure and its advantages have been described in detail, it should be understood that various changes, substitutions and alterations can be made herein without departing from the spirit and scope of the disclosure as defined by the appended claims.

What is claimed is:

1. A method for interacting with Internet Protocol version 6 (IPv6) compatible devices in a communications system, the method comprising:
receiving, by a dual-stack device, a first control message from a server, the dual-stack device comprising an Internet Protocol version 4 (IPv4) protocol stack and an IPv6 protocol stack, wherein the first control message includes an IPv4 level indicator that indicates support for IPv4 in the communications system; and
adjusting, by the dual-stack device, a configuration of the IPv4 protocol stack in accordance with the IPv4 level indicator.

2. The method of claim 1, wherein adjusting the configuration of the IPv4 protocol stack comprises:
configuring the IPv4 protocol stack to refrain from communicating IPv4 messages when the IPv4 level indicator indicates that IPv4 is not supported.

3. The method of claim 1, wherein the first control message comprises one of a Neighbor Discovery router advertisement message and a IPv6 dynamic host configuration protocol (DHCPv6) reconfigure message.

4. The method of claim 3, wherein the first control message is a Neighbor Discovery router advertisement message, and wherein the server comprises a Neighbor Discovery server.

5. The method of claim 3, wherein the first control message is a DHCPv6 reconfigure message, and wherein the server comprises a DHCPv6 server.

6. The method of claim 3, wherein the IPv4 level indicator comprises a type code, a length value, and a v4 level value.

7. The method of claim 1, wherein the first control message comprises an IPv6 dynamic host configuration protocol (DHCPv6) response message.

8. The method of claim 7, wherein the server comprises a DHCPv6 server.

9. The method of claim 7, further comprising sending a second control message prior to receiving the first control message.

10. The method of claim 9, wherein the second control message comprises a DHCPv6 request message.

11. The method of claim 10, wherein the IPv4 level indicator comprises an option number, an option length value, and a v4 level value.

12. A method for interacting with Internet Protocol version 6 (IPv6) and Internet Protocol version 4 (IPv4) compatible devices, the method comprising:
determining, by a server, an IPv4 level indicator in accordance with IPv4 support in a communications system including the server;
generating, by the server, a first control message, where the first control message includes the IPv4 level indicator; and
sending, by the server, the first control message.

13. The method of claim 12, wherein the first control message comprises one of an IPv6 dynamic host configuration protocol (DHCPv6) reconfigure message and a Neighbor Discovery router advertisement message.

14. The method of claim 13, wherein the IPv4 level indicator comprises a type code, a length value, and a v4 level value.

15. The method of claim 12, further comprising receiving a second control message prior to generating the first control message.

16. The method of claim 15, wherein the second control message comprises an IPv6 dynamic host configuration protocol (DHCPv6) request message.

17. The method of claim 16, wherein the first control message comprises a DHCPv6 response message.

18. The method of claim 17, wherein the IPv4 level indicator comprises an option number, an option length value, and a v4 level value.

19. A dual-stack device comprising:
an Internet Protocol version 4 (IPv4) protocol stack and an Internet Protocol version 6 (IPv6) protocol stack;
a receiver configured to receive a first control message from a server, wherein the first control message includes an IPv4 level indicator that indicates support for IPv4 in a communications system; and
a processor operatively coupled to the receiver, to the IPv4 protocol stack, and the IPv6 protocol stack, the processor configured to adjust a configuration of the IPv4 protocol stack in accordance with the IPv4 level indicator.

20. The dual-stack device of claim 19, wherein the processor is configured to adjust the IPv4 protocol stack to refrain from communicating IPv4 messages when the IPv4 level indicator indicates that IPv4 is not supported.

21. The dual-stack device of claim 19, wherein the first control message comprises one of an IPv6 dynamic host configuration protocol (DHCPv6) reconfigure message and a Neighbor Discovery router advertisement message.

22. The dual-stack device of claim 19, wherein the first control message comprises an IPv6 dynamic host configuration protocol (DHCPv6) response message.

23. The dual-stack device of claim 22, further comprising a transmitter operatively coupled to the processor, the transmitter configured to send a second control message prior to receiving the first control message.

24. The dual-stack device of claim 23, wherein the second control message comprises a DHCPv6 request message.

25. A method for interacting with Internet Protocol version 6 (IPv6) dynamic host configuration protocol (DHCPv6) compatible devices in a communications system, the method comprising:
receiving, by a dual-stack device, a first DHCPv6 control message from a DHCPv6 server, the dual-stack device comprising an Internet Protocol version 4 (IPv4) protocol stack and an IPv6 protocol stack, wherein the first control message includes an IPv4 level indicator that indicates support for IPv4 in the communications system; and
adjusting, by the dual-stack device, a configuration of the IPv4 protocol stack in accordance with the IPv4 level indicator.

26. The method of claim 25, wherein the first DHCPv6 control message comprises a DHCPv6 reconfigure message.

27. The method of claim 26, wherein the the IPv4 level indicator comprises a type code, a length value, and a v4 level value.

28. The method of claim 25, wherein the first DHCPv6 control message comprises a DHCPv6 response message.

29. The method of claim 28, further comprising sending a second DHCPv6 control message prior to receiving the first DHCPv6 control message.

30. The method of claim 29, wherein the second DHCPv6 control message comprises a DHCPv6 request message.
